(19) United States
(12) Patent Application Publication
(10) Pub. No.: US 2007/0253186 A1
(43) Pub. Date: Nov. 1, 2007

(54) Backlight module and liquid crystal display incorporating same

(75) Inventors: Chih-Chung Hsiao, Miao-Li (TW); Yi-Fu Lin, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/796,782

(22) Filed: Apr. 30, 2007

(30) Foreign Application Priority Data
Apr. 28, 2006 (TW) 95115319

(51) Int. Cl. G09F 13/04

(52) U.S. Cl. 362/97

(57) ABSTRACT

An exemplary backlight module (20) includes a bottom tray (280), a light guide plate (250), and a light source assembly (270). The bottom tray includes a bottom plate (281) and a pair of opposite holding arms (282) extending from the bottom plate. The light guide plate is provided on the bottom plate, and includes a light incident surface (252). The light source assembly includes a light source (271) located adjacent the light incident surface of the light guide plate and a reflective shell (272) accommodating the light source. The reflective shell includes two fixing arms (275) extending from two opposite ends thereof. The light source assembly is fixed to the bottom tray by engagement of the holding arms of the bottom tray and the fixing arms of the light source assembly.

### FIELD OF THE INVENTION

The present invention relates to a backlight module that has a frame with an elastic member, and a liquid crystal display including the backlight module.

### GENERAL BACKGROUND

Liquid crystal displays are commonly used as displays for compact electronic apparatuses. This is because liquid crystal displays not only provide good quality images using little power, but are also conveniently thin. Because liquid crystal in a liquid crystal display does not emit any light itself, the liquid crystal requires a light source to clearly and sharply display text and images. Therefore, liquid crystal displays typically require a backlight module.

Referring to FIG. 8, a typical liquid crystal display 1 includes a liquid crystal panel 11 and a backlight module 10 for illustrating the liquid crystal panel 11. The backlight module 10 includes a light guide plate 110, a light source assembly 120, a plastic frame 130, a bottom tray 140, a reflective plate 150, an upper brightness enhancement film (BEF) 160, a lower BEF 170, and a diffusing film 180. The plastic frame 130 and the bottom tray 140 cooperatively accommodate the light guide plate 110, the light source assembly 120, the reflective plate 150, the upper BEF 160, the lower BEF 170, and the diffusing film 180.

The bottom tray 140 includes a rectangular bottom plate 141 and two sidewalls 142 perpendicularly extending from two opposite sides of the bottom plate 141.

The light guide plate 110 includes a light emitting surface 111, a light incident surface 112 adjacent the light emitting surface 111, and a bottom surface 113 opposite to the light emitting surface 111. The light source assembly 120 includes a light source 121 and a reflective shell 122. The light source 121 is linear, and is located adjacent the light incident surface 112 of the light guide plate 110. The reflective shell 122 has a U-shaped cross-section, and generally surrounds three sides of the light source 121. The reflective shell 112 is generally connected to the bottom tray 140 via a conductive tape or screws in order to be grounded. The reflective plate 150 is located adjacent the bottom surface 113 of the light guide plate 110. The diffusing film 180, the lower BEF 170, and the upper BEF 160 are disposed adjacent the light emitting surface 111 of the light guide plate 110 in that order, from bottom to top.

The liquid crystal display 1 further includes a top bezel 12. The top bezel 12 cooperates with the bottom tray 140 to accommodate and fix the liquid crystal panel 11 and the backlight module 10.

The light source assembly 120 and the reflective plate 150 are both disposed on the bottom plate 141, and the light source assembly 120 is not fixed to the bottom tray 140. Therefore when the liquid crystal display 1 is subjected to vibration or shock during operation or transportation, the reflective plate 150 is liable to be damaged by the light source assembly 120. When this happens, optical performance of the liquid crystal display I may be seriously impaired as a result. In addition, if the light source 121 is broken and needs be renewed, the whole liquid crystal display 1 must be disassembled such that the light source 121 can be taken out. During the disassembling process, the optical members of the liquid crystal display 1 may be damaged, thus impairing optical performances of the liquid crystal display 1. Furthermore, the use of the conductive tape or the screws increases an overall cost of the liquid crystal display 1.

What is needed, therefore, is a backlight module that can overcome the above-described deficiencies. What is also needed is a liquid crystal display employing such a backlight module.

### SUMMARY

In one preferred embodiment, a backlight module includes a bottom tray, a light guide plate, and a light source assembly. The bottom tray includes a bottom plate and a pair of opposite holding arms extending from the bottom plate. The light guide plate is provided on the bottom plate, and includes a light incident surface. The light source assembly includes a light source located adjacent the light incident surface of the light guide plate and a reflective shell accommodating the light source. The reflective shell includes two fixing arms extending from two opposite ends thereof. The light source assembly is fixed to the bottom tray by engagement of the holding arms of the bottom tray and the fixing arms of the light source assembly.

Other novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views and all the views are schematic.

FIG. 1 is an exploded, isometric view of a liquid crystal display according to a first embodiment of the present invention, the liquid crystal display including a bottom tray, two light source assemblies, and a plastic frame.

FIG. 2 is an isometric view of the bottom tray of the liquid crystal display of FIG. 1.

FIG. 3 is an isometric view of one of the light source assemblies of the liquid crystal display of FIG. 1.

FIG. 4 is an isometric view of the plastic frame of the liquid crystal display of FIG. 1.

FIG. 5 is similar to FIG. 2, but showing a corresponding view in the case of a bottom tray of a liquid crystal display according to a second embodiment of the present invention.

FIG. 6 is similar to FIG. 2, but showing a corresponding view in the case of a bottom tray of a liquid crystal display according to a third embodiment of the present invention.

FIG. 7 is similar to FIG. 2, but showing a corresponding view in the case of a bottom tray of a liquid crystal display according to a fourth embodiment of the present invention.

FIG. 8 is an exploded, isometric view of a conventional liquid crystal display.

### DETAILED DESCRIPTION OF PREFERRED EMBODIMENTS

Reference will now be made to the drawings to describe the preferred embodiments in detail.

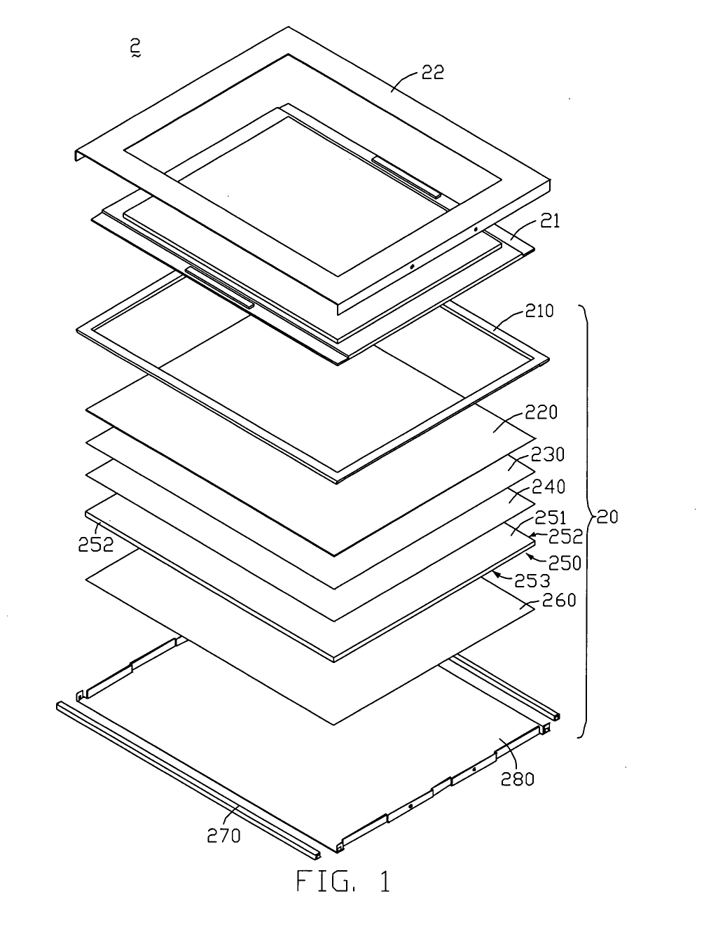

Referring to FIG. 1, a liquid crystal display 2 according to a first embodiment of the present invention is shown. The liquid crystal display 2 includes a liquid crystal panel 21 and a backlight module 20 for illuminating the liquid crystal panel 21. The backlight module 20 includes a plastic frame 210, an upper BEF 220, a lower BEF 230, a diffusing film 240, a light guide plate 250, a reflective plate 260, two light source assemblies 270, and a bottom tray 280. The plastic frame 210 cooperates with the bottom tray 280 to accommodate the upper BEF 220, the lower BEF 230, the diffusing film 240, the light guide plate 250, the reflective plate 260, and the light source assemblies 270.

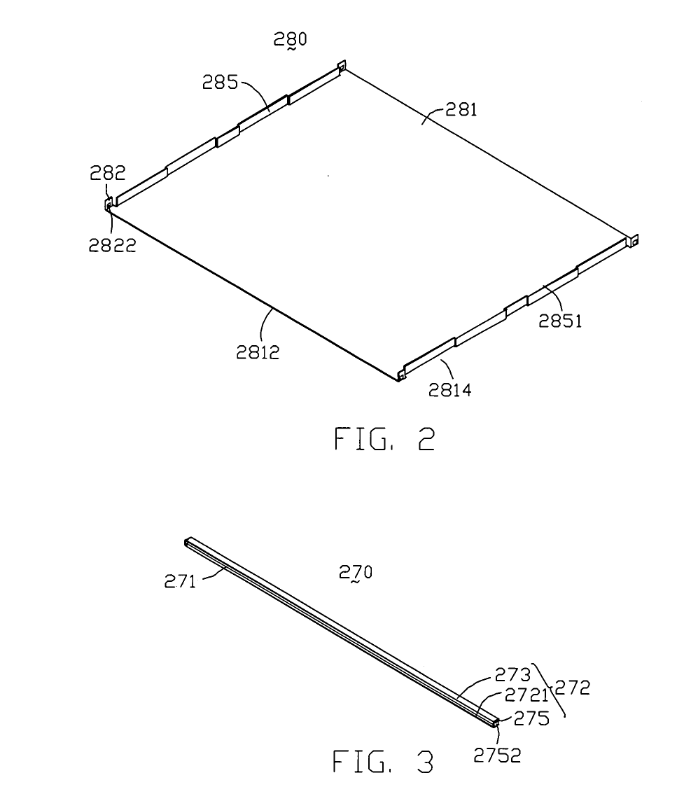

Referring to FIG. 2, the bottom tray 280 includes a rectangular bottom plate 281. The bottom plate 281 includes two symmetrically opposite first edges 2812 and two symmetrically opposite second edges 2814. Each of the second edges 2814 of the bottom plate 281 has two holding arms 282 upwardly extending therefrom, and a first sidewall 285 upwardly extending therefrom. The two holding arms 282 are located at two ends of each second edge 2814, respectively. A holding member 2822 is recessed at each holding arm 282. The first sidewall 285 is located between the two holding arms 282, and includes a plurality of recesses 2851.

The light guide plate 250 includes a light emitting surface 251, two opposite light incident surfaces 252 both adjacent the light emitting surface 251, and a bottom surface 253 opposite to the light emitting surface 251. The light guide plate 250 is located on the bottom plate 281 of the bottom tray 280. The diffusing film 240, the lower BEF 230 and the upper BEF 220 are disposed adjacent the light emitting surface 251 of the light guide plate 250 in that order, from bottom to top. The reflective plate 260 is disposed adjacent the bottom surface 253 of the light guide plate 250.

Referring also to FIG. 3, each of the light source assemblies 270 includes a light source 271 and a reflective shell 272. The light source 271 is generally a linear light source, such as a cold cathode fluorescent lamp (CCFL). The reflective shell 272 includes a reflective body 273 and two fixing arms 275. The reflective body 273 has a generally U-shaped form, thereby defining an opening 2721 adjacent the respective light incident surface 252 of the light guide plate 250. The reflective body 273 has a same length as that of the light source 271, and accommodates the light source 271 therein. The fixing arms 275 are located at two opposite ends of the respective reflective body 273. In the illustrated embodiment, each of the fixing arms 275 is an elastic strip, and includes a fixing member 2752 outwardly protruding therefrom.

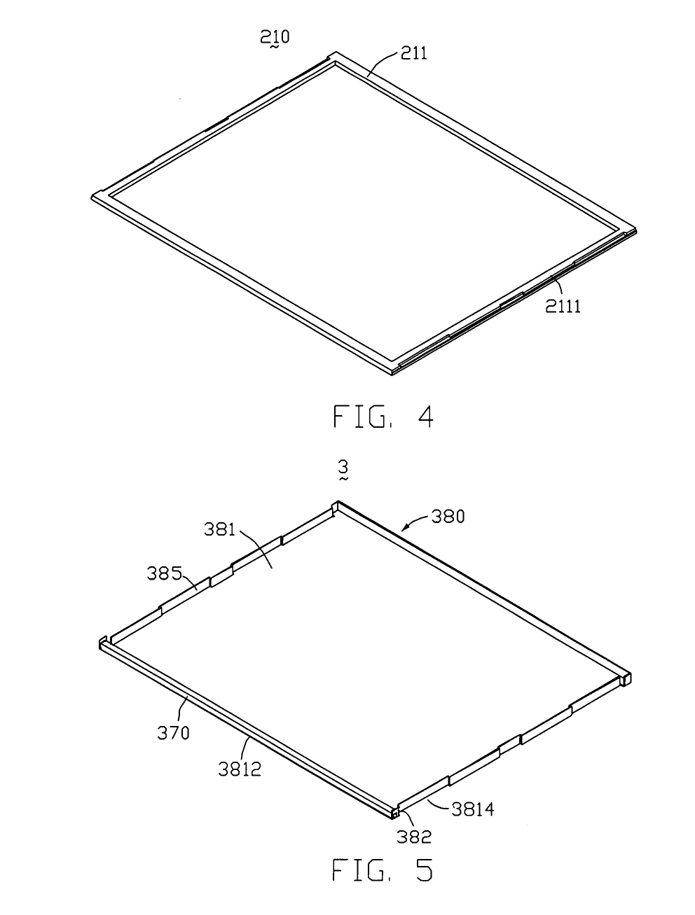

Referring also to FIG. 4 the plastic frame 210 has a generally rectangular form. The plastic frame 210 includes two pairs of symmetrically opposite second sidewalls 211. A plurality of protrusions 2111 extend from two opposite second sidewalls 211, which second sidewalls 211 correspond to the two first sidewalls 285 of the bottom tray 280, respectively. Locations and sizes of the protrusions 2111 correspond to those of the recesses 2851, respectively. Thus, the plastic frame 210 and the bottom tray 280 are assembled by engagement of the protrusions 2111 and the recesses 2851. In the illustrated embodiment, the plastic frame 210 is made from polycarbonate.

The liquid crystal display 2 further includes a top bezel 22. The top bezel 22 cooperates with the bottom tray 280 to accommodate and fix the liquid crystal panel 21 and the backlight module 20.

The liquid crystal display 2 can be assembled as followings. First, the light source assemblies 270 are respectively placed at the two opposite first edges 2812, with the holding members 2822 holding the fixing members 2752. Second, the reflective plate 260, the light guide plate 250, the diffusing film 240, the lower BEF 230, and the upper BEF 220 are placed on the bottom plate 281 of the bottom tray 280 in that order from bottom to top, the two incident surfaces 252 facing the two light source assemblies 270 respectively. Third, the plastic frame 210 is fixed to the bottom tray 280 by engagement of the protrusions 2111 and the recesses 2851, thereby cooperatively fixing the above optical members of the backlight module 20. Fourth, the liquid crystal panel 21 is placed on the plastic frame 210, and the top bezel 22 is fixed to the bottom tray 280, thereby cooperatively fixing and accommodating the liquid crystal panel 21 and the backlight module 20.

With the above-described configurations, when the liquid crystal display 2 is assembled, the light source assemblies 270 are fixed to the bottom tray 280 by the fixing arms 275 cooperating with the holding arms 282. This means that the reflective plate, 260 can be prevented from being damaged by the light source assemblies 270 even when the liquid crystal display 2 is subjected to vibration or shock during operation or transportation. Thus, reliability of the liquid crystal display 2 is improved, and optical performance of the liquid crystal display 2 is both improved and maintained. In addition, because the light source assemblies 270 are elastically held, they can be easily taken out of the liquid crystal display 2 if necessary. This makes the liquid crystal display 2 easy to be maintained. Furthermore, the reflective shells 272 are fixed to the bottom tray 280, thus being connected to ground.

Referring to FIG. 5, a liquid crystal display 3 according to a second embodiment of the present invention is similar to the liquid crystal display 2. However, the liquid crystal display 3 includes a light source assembly 370 and a bottom tray 380. The bottom tray 380 includes a rectangular bottom plate 381. The bottom plate 381 includes a first edge 3812 and three second edges 3814. A holding arm 382 and a sidewall 385 extend from each of the second edges 3814, respectively. The holding arms 382 are located adjacent the first edge 3812, and are symmetrically opposite to each other. The light source assembly 370 is disposed at the first edge 3812 of the bottom plate 381, and is held between the two holding arms 382. The liquid crystal display 3 can achieve advantages similar to those described above in relation to the liquid crystal display 2.

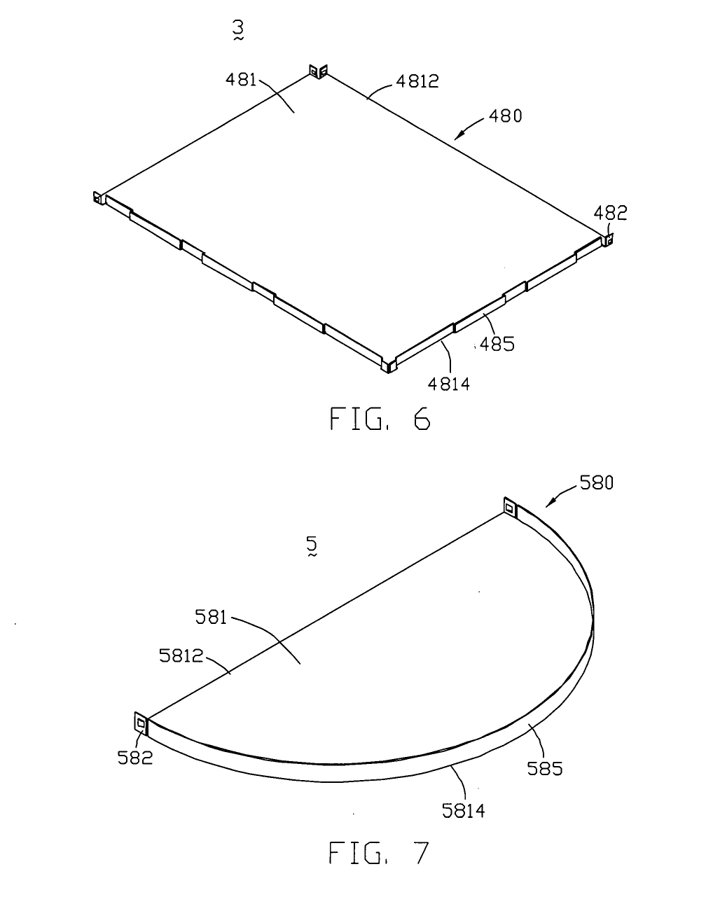

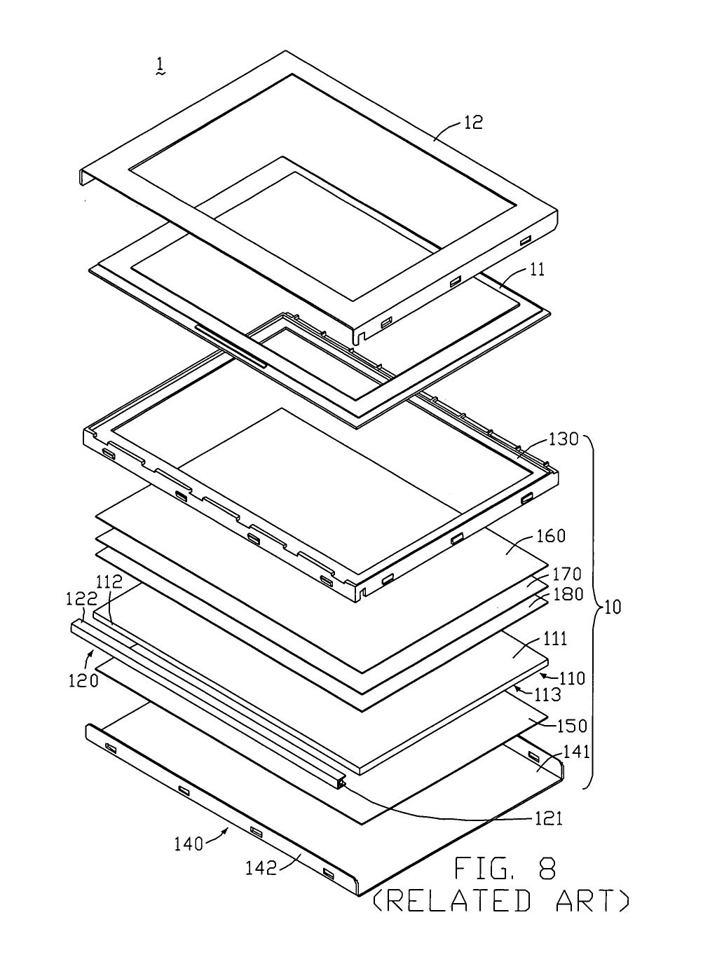

Referring to FIG. 6, a liquid crystal display 4 according to a third embodiment of the present invention is similar to the liquid crystal display 2. However, the liquid crystal display 4 includes two light source assemblies (not shown) and a bottom tray 480. The bottom tray 480 includes a rectangular bottom plate 481. The bottom plate 481 includes two adjacent first edges 4812 and two adjacent second edges 4814. Two opposite holding arms 482 are formed at two ends of each first edge 4812. Each of the light source assemblies is disposed at the respective first edges 4812 of the bottom plate 481, and is held between the respective pair of holding arms 482. The liquid crystal display 4 can achieve advantages similar to those described above in relation to the liquid crystal display 2.

Referring to FIG. 7, a liquid crystal display 5 according to a fourth embodiment of the present invention is similar to the liquid crystal display 2. However, the liquid crystal display 5 includes a bottom tray 580, and the bottom tray 580 includes a semi-circular bottom plate 581. The bottom plate 581 includes a straight first edge 5812 and a curved second edge 5814. Two holding arms 582 and a curved sidewall 585 extend from the second edge 5814, respectively. The holding arms 582 are located adjacent the first edge 5812, and are symmetrically opposite to each other. A light source assembly (not shown) is disposed at the first edge 5812 of the bottom plate 581, and is held between the two holding arms 582. The liquid crystal display can achieve advantages similar to those described above in relation to the liquid crystal display 2.

Further or alternative embodiments may include the followings. In one example, the holding members 2822 outwardly protrude. In such case, the fixing members 2752 are recessed.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a bottom tray comprising a bottom plate and a pair of opposite holding arms extending from the bottom plate;
a light guide plate provided on the bottom plate, the light guide plate comprising a light incident surface; and
a light source assembly comprising a light source located adjacent the light incident surface of the light guide plate and a reflective shell accommodating the light source, the reflective shell comprising two fixing arms extending from two opposite ends thereof, the light source assembly being fixed to the bottom tray by engagement of the holding arms of the bottom tray and the fixing arms of the light source assembly.

2. The backlight module as claimed in claim 1, wherein the light source is linear.

3. The backlight module as claimed in claim 2, wherein the light source is a cold cathode fluorescent lamp.

4. The backlight module as claimed in claim 1, wherein the holding arms and the fixing members are elastic.

5. The backlight module as claimed in claim 1, wherein each of the holding arms comprises a holding member, and each of the fixing arms comprises a fixing member engaged to the respective holding member.

6. The backlight module as claimed in claim 5, wherein the holding member protrudes from the holding arm, and the fixing member is recessed at the fixing arm.

7. The backlight module as claimed in claim 5, wherein the holding member is recessed at the holding arm, and the fixing member protrudes from the fixing arm.

8. The backlight module as claimed in claim 1, wherein the bottom plate is rectangular, and comprises a first edge and three second edges.

9. The backlight module as claimed in claim 8, wherein the two holding arms are located at two ends of the first edge of the bottom plate, and cooperatively hold the light source assembly at the first edge of the bottom plate.

10. The backlight module as claimed in claim 1, wherein the bottom plate is rectangular, and comprises two opposite first edges and two opposite second edges.

11. The backlight module as claimed in claim 10, further comprising another light source assembly, wherein the bottom tray comprises two pair of opposite holding arms, and each pair of holding arms are located at two opposite ends of the respective first edge of the bottom plate and cooperatively hold a light source assembly at the first edge of the bottom plate.

12. The backlight module as claimed in claim 1, wherein the bottom plate is rectangular, and comprises two adjacent first edges and two adjacent second edges.

13. The backlight module as claimed in claim 12, wherein further comprising another light source assembly, wherein the bottom tray comprises two pair of opposite holding arms, and each pair of holding arms are located at two opposite ends of the respective first edge of the bottom plate and cooperatively hold a light source assembly at the first edge of the bottom plate.

14. The backlight module as claimed in claim 1, wherein the bottom plate is semi-circular, and comprise a straight first edge and a curved second edge.

15. The backlight module as claimed in claim 14, wherein the two holding arms are located at two ends of the first edge of the bottom plate, and cooperatively hold the light source assembly at the first edge bottom plate.

16. A backlight module comprising:
a bottom tray comprising a pair of holding arms thereat;
a light guide plate provided on the bottom plate; and
a light source assembly located adjacent a side of the light guide plate, the light source assembly comprising:
a light source; and
a reflective shell accommodating the light source therein, the reflective shell comprising a pair of fixing arms thereat, the fixing arms and the holding arms cooperatively fixing the light source assembly to the bottom tray.

17. A liquid crystal display comprising:
a liquid crystal panel; and
a backlight module configured for illuminating the liquid crystal panel, the backlight module comprising:
a bottom tray comprising a bottom plate and a pair of opposite holding arms extending from the bottom plate;
a light guide plate provided on the bottom plate, the light guide plate comprising a light incident surface; and
a light source assembly comprising a light source located adjacent the light incident surface of the light guide plate and a reflective shell accommodating the light source, the reflective shell comprising two fixing arms extending from two opposite ends thereof, the light source assembly being fixed to the bottom tray by engagement of the holding arms of the bottom tray and the fixing arms of the light source assembly.
